(19) United States
(12) Patent Application Publication
(10) Pub. No.: US 2018/0132510 A1
(43) Pub. Date: May 17, 2018

(54) CODE-BASED FOOD PROCESSING MACHINE

(71) Applicant: Vela Blend, Inc., Gilbert, AZ (US)

(72) Inventors: Matthew Sedlacek, Gilbert, AZ (US); Joseph Velasquez, Scottsdale, AZ (US); Angie Nguyen, Tempe, AZ (US)

(21) Appl. No.: 15/355,016

(22) Filed: Nov. 17, 2016

(51) Int. Cl. A23L 5/00; G06K 7/14; G06K 7/10

(52) U.S. Cl. CPC A23L 5/00; G06K 7/10366; G06K 7/1413; G06K 7/1417

(57) ABSTRACT

Food processing can include obtaining a food-pack code from a food-pack containing a set of ingredients for a food processing machine; and applying a set of processing parameters to a set of food processing mechanisms of the food processing machine in response to the food-pack code.

### BACKGROUND

A food processing machine can include mechanisms that enable a user to render a food preparation from a set of ingredients. For example, a blender can include a carafe with a blade mechanism and a motor for blending a set of ingredients inside the carafe. A user of the blender can add ingredients to the carafe, set the processing controls manually, e.g., blending time, blending speed, etc., and then blend the ingredients. A blender can include a control panel with start/stop controls and manual processing controls, e.g., blending time controls, blending speed controls, etc.

### SUMMARY

In general, in one aspect, the invention relates to a code-based food processing machine. The food processing machine can include: a code sensor for obtaining a food-pack code from a food-pack containing a set of ingredients for the food processing machine; and a code handler for applying a set of processing parameters to a set of food processing mechanisms of the food processing machine in response to the food-pack code.

In general, in another aspect, the invention relates to a method for code-based food processing. The method can include: obtaining a food-pack code from a food-pack containing a set of ingredients for a food processing machine; and applying a set of processing parameters to a set of food processing mechanisms of the food processing machine in response to the food-pack code.

In general, in another aspect, the invention relates to a method for reordering a supply of food-packs for a code-based food processing machine. The method can include: obtaining a food-pack code from a food-pack containing a set of ingredients for a food processing machine; determining a current inventory of the supplies in response to the food-pack code; and displaying a user interface element that enables a user to trigger a reorder of the supplies if the current inventory is below a threshold.

Other aspects of the invention will be apparent from the following description and the appended claims.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 illustrates a code-based food processing machine in one or more embodiments.

FIG. 2 illustrates an embodiment of a code-based food processing machine that includes mechanisms for adapting processing parameters to a set of user preferences.

FIG. 3 illustrates an embodiment of a code-based food processing machine that includes logging mechanisms.

FIG. 4 illustrates an embodiment of a code-based food processing machine that includes notification mechanisms.

FIG. 5 illustrates an embodiment of a code-based food processing machine that includes mechanisms for identifying a user.

FIG. 6 shows a set of logs generated by a code-based food processing machine in one or more embodiments.

FIG. 7 illustrates an embodiment of a code-based food processing machine that includes a reordering mechanism.

FIG. 8 shows how a mobile device can be used with a code-based food processing machine in one or more embodiments.

FIG. 9 illustrates an embodiment of a code-based food processing machine that communicates with a data warehouse via a mobile device.

FIG. 10 illustrates an embodiment of a code-based food processing machine in which a food-pack code is manually scanned from a food-pack.

FIG. 11 illustrates an embodiment of a code-based food processing machine in which a food-pack code is automatically scanned from a food-pack.

FIG. 12 illustrates a method for code-based food processing in one or more embodiments.

FIG. 13 illustrates a method for reordering a supply of food-packs for a code-based food processing machine in one or more embodiments.

FIG. 14 illustrates a computing system upon which portions of a method for code-based food processing and reordering can be implemented.

### DETAILED DESCRIPTION

Reference will now be made in detail to the various embodiments of the present disclosure, examples of which are illustrated in the accompanying drawings. Like elements in the various figures are denoted by like reference numerals for consistency. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, have not been described in detail so as not to unnecessarily obscure aspects of the present disclosure.

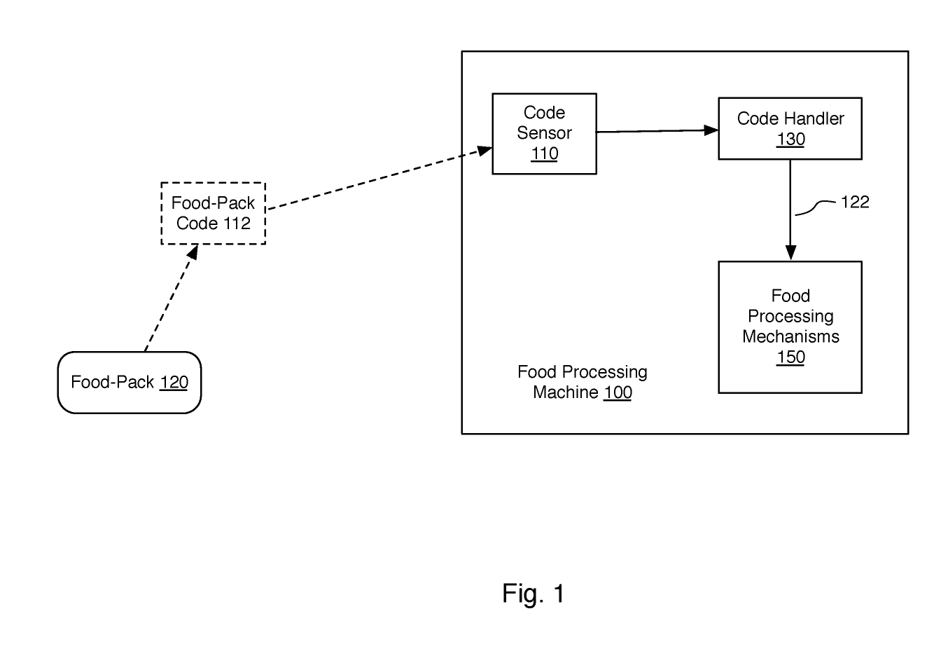

FIG. 1 illustrates a code-based food processing machine 100 in one or more embodiments. The food processing machine 100 includes a code sensor 110 for obtaining a food-pack code 112 from a food-pack 120 containing a set of ingredients for processing by the food processing machine 100. The food processing machine 100 includes a code handler 130 for applying a set of processing parameters 122 to a set of food processing mechanisms 150 of the food processing machine 100 in response to the food-pack code 112.

In one or more embodiments, the food-pack 120 contains a set of freeze-dried ingredients for processing by the food processing machine 100. The freeze-dried ingredients can be for a soup, a smoothie, a nutritional drink, etc.

The food-pack code 112 can be imparted onto the food-pack 120 in a printed pattern, e.g., a bar code, a quick response (QR) code, etc. The code sensor 110 can include an optical mechanism for reading the printed pattern off of the food-pack 120.

The food-pack code 112 can be programmed into a radio-frequency identification (RFID) tag on the food-pack 120. The code sensor 110 can include an RFID reader for obtaining the food-pack code 112 from the RFID tag of the food-pack 120.

The food-pack code 112 can be indicated in a pattern of a physical structure formed on the food-pack 120, e.g., a physical key pattern. The code sensor 110 can read the key pattern, e.g., via a physical coupling to the physical structure formed on the food-pack 120, or optical sensing, etc.

The processing parameters 122 can control a variety of functions of the food processing mechanisms 150. The food processing mechanisms 150 can include any food processing mechanisms, e.g., blending mechanisms, mixing mechanisms, steaming mechanisms, heating mechanisms, etc.

In an example embodiment, the food processing mechanisms 150 can include water reservoirs, heating elements for heating water, pumps for injecting water into the food-pack 120, motors for blending the ingredients inside the food-pack 120, etc. The processing parameters 122 in such an embodiment can include parameters for controlling water temperature, water volume, water injection intervals, blend speed/time, etc.

The processing parameters 122 can be included in the food-pack code 112 or derived from the food-pack code 112. For example, the food-pack code 112 can be mapped to the processing parameters 122 using, e.g., a lookup table.

The food-pack code 112 can identify the food-pack 120. For example, the food-pack code 112 can include a globally unique identifier that enables identification of the food-pack 120 in a chain of commerce.

The food-pack code 112 can include indications of a required machine type for processing the food-pack 120. For example, the food-pack 120 may require particular water handling capabilities that may not be implemented in all models of the food processing machine 100.

The food-pack code 112 can include indications of whether or not the food-pack 120 requires process steps that must be performed manually by a user of the food processing machine 100, as well as what process steps are required from the user. The food-pack code 112 can specify the manual process steps and the appropriate points during processing of the food-pack 120 for a user to perform those manual steps. For example, a manual process step can include a user adding ingredients to a soup toward the end of a blend cycle to make the soup come out chunky.

The food-pack code 112 can include a set of parameters for a cleaning cycle of the food processing machine 100. For example, cleaning parameters for a soup, a smoothie, a nutrition blend, etc., can include respective parameters for cleaning time, amount of water for cleaning, a blend time for cleaning, etc.

The food-pack code 112 can include ingredient warnings associated with the food-pack 120. One example of an ingredient warning is an expiration date associated with the food-pack 120. Other examples of ingredient warnings include any potential food allergies pertaining to the ingredients of the food-pack 120. For example, the ingredients of the food-pack 120 may include traces of nuts, lactose, etc. Still other examples of ingredient warnings include indications of whether or not the ingredients of the food-pack 120 satisfy vegan, vegetarian, and kosher, etc., requirements.

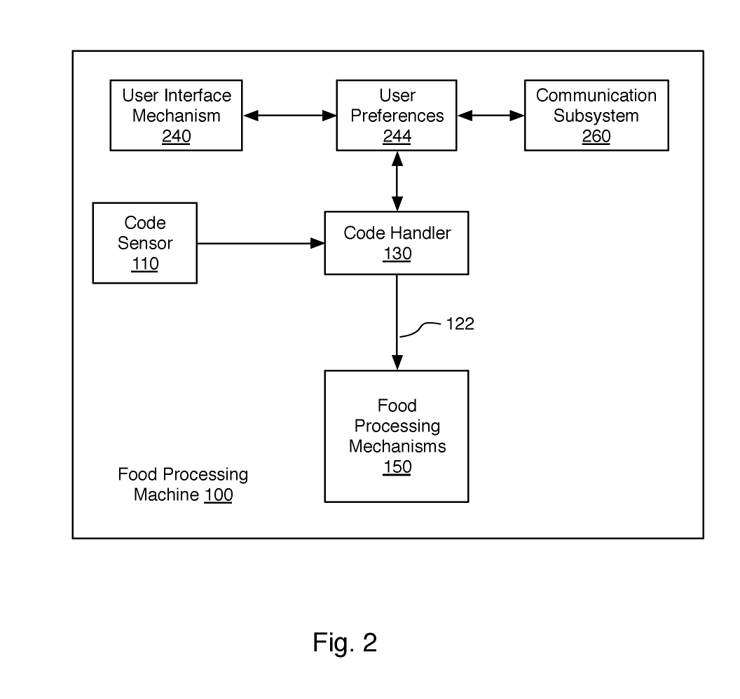

FIG. 2 illustrates an embodiment of the food processing machine 100 in which the code handler 130 adapts the processing parameters 122 to a set of user preferences 244. For example, the user preferences 244 can specify preferences for water temperature, thickness of soup, etc.

The code handler 130 can alter any one or more of the processing parameters 122 in accordance with user preferences 244. For example, if the user preferences 244 specify a preference for thick soups, the code handler 130 can alter the water volume parameters included in the processing parameters 122 to yield a thick soup preparation from the ingredients in the food-pack 120.

In one or more embodiments, a user can enter the user preferences 244 via a user interface mechanism 240 of the food processing machine 100, e.g., a touchscreen, keypad, speech interface, etc. In one or more embodiments, the user preferences 244 can be obtained from an external device, e.g., a mobile device, wearable device, personal computer, etc., via a communication subsystem 260, e.g., Wi-Fi, Bluetooth, NFC, cellular links, optical links, e.g., infrared, sound, etc.

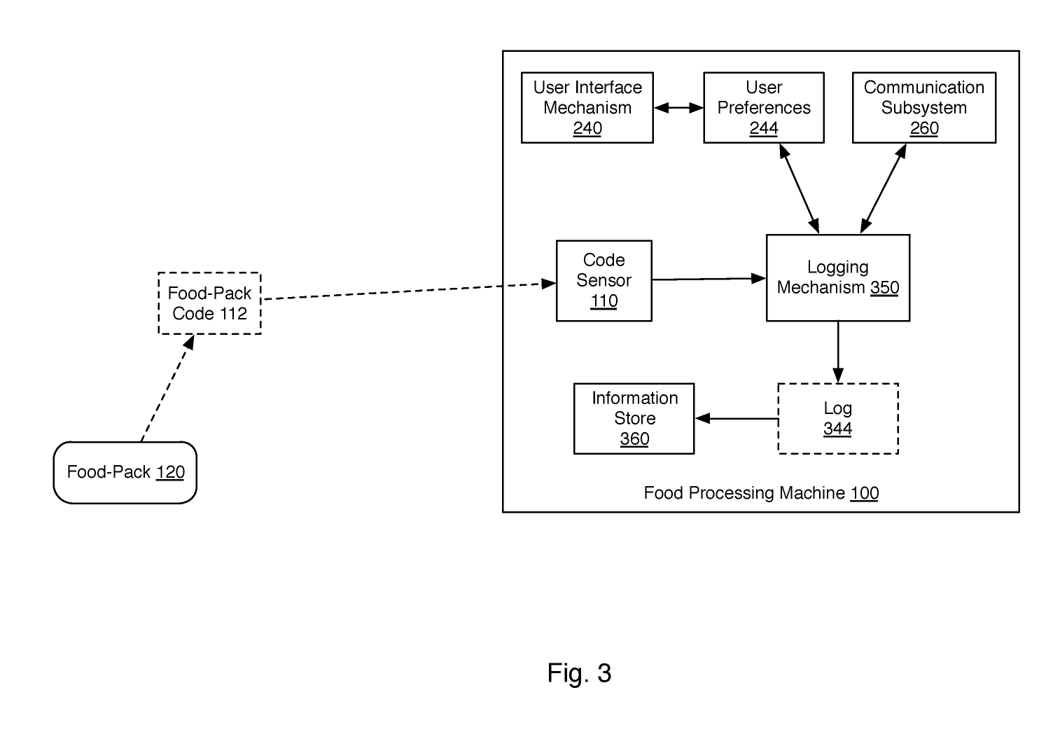

FIG. 3 illustrates an embodiment of the food processing machine 100 that includes a logging mechanism 350. The logging mechanism 350 in one or more embodiments generates a log 344 pertaining to the food-pack 120. The log 344 can include a set of descriptive information pertaining to a processing of the food-pack 120.

The log 344 can identify the food-pack 120. For example, the log 344 can include a globally unique identifier included in the food-pack code 112.

The log 344 can identify a user who prepares the food-pack 120. For example, a user identifier stored in the user preferences 244 can be included in the log 344. A user can enter their user identifier into the user preferences 244 via the user interface mechanism 240. A user identifier can be obtained via the communication subsystem 260 from a mobile device, wearable device, etc., of a user.

The log 344 can include a time of the processing of the food-pack 120. For example, the logging mechanism 350 can generate a timestamp, including date, when the food-pack code 112 is read from the food-pack 120.

The log 344 can identify the food processing machine 100. For example, log 344 can include a serial number of the food processing machine 100.

The log 344 can include one or more status codes, completion codes, error codes, maintenance codes, etc., pertaining to the processing of the food-pack 120 by the food processing machine 100. For example, log 344 can include a status code indicating whether or not the food-pack 120 was successfully processed by the food processing machine 100 along with any relevant error codes, codes indicating processing overrides made by a user, maintenance status of the food processing machine 100 or parts of the food processing machine, etc.

The logging mechanism 350 can upload the log 344 to an external device, data store, data warehouse, etc., via the communication subsystem 260. The logging mechanism 350 can generate a corresponding log each time a food-pack code is scanned from a food-pack. The logging mechanism 350 can upload a corresponding log each time a food-pack has completed processing in the food processing machine 100.

In one or more embodiments, the logging mechanism 350 records the log 344 in an information store 360. The information store 360 can record any number logs. Each log recorded in the information store 360 can pertain to a corresponding food-pack processed by the food processing machine 100.

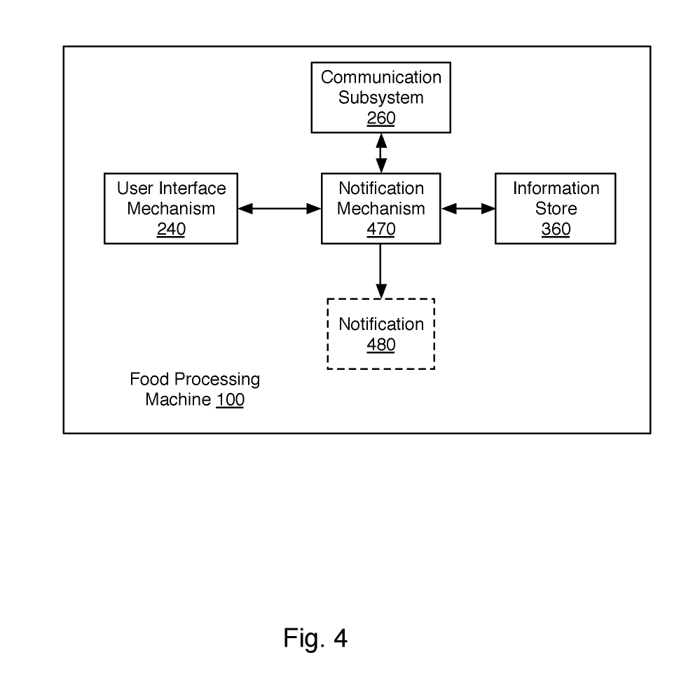

FIG. 4 illustrates an embodiment of the food processing machine 100 that includes a notification mechanism 470. The notification mechanism 470 generates a notification 480 for a user of the food processing machine 100 in response to the food-pack code 112.

In one or more embodiments, the notification 480 can pertain to an inventory for the food processing machine 100. For example, the notification 480 can pertain to how many food-packs remain in an inventory for the food processing machine 100, e.g., for a particular user of the food processing machine 100, etc.

In one or more embodiments, the notification 480 can pertain to maintenance of the food processing machine 100. For example, the notification 480 can indicate when a maintenance operation for the food processing machine is due, overdue, etc.

In one or more embodiments, the notification 480 can pertain to a set of nutritional information for a user of the food processing machine 100. For example, the notification 480 can indicate how many food-packs, calories, protein, fiber, etc., a particular user has consumed.

The notification mechanism 470 can provide the notification 480 to a user via the user interface mechanism 240. The notification mechanism 470 can send the notification 480 to a device of a user, e.g., a mobile device, wearable device, computer system, etc., via the communication subsystem 260.

In one or more embodiments, the notification mechanism 470 can obtain the notification 480 via the communication subsystem 260 and display it via the user interface mechanism 240. For example, a user device, e.g., mobile device, or a data warehouse, etc., can generate the notification 480 in response to logs uploaded by the logging mechanism 350.

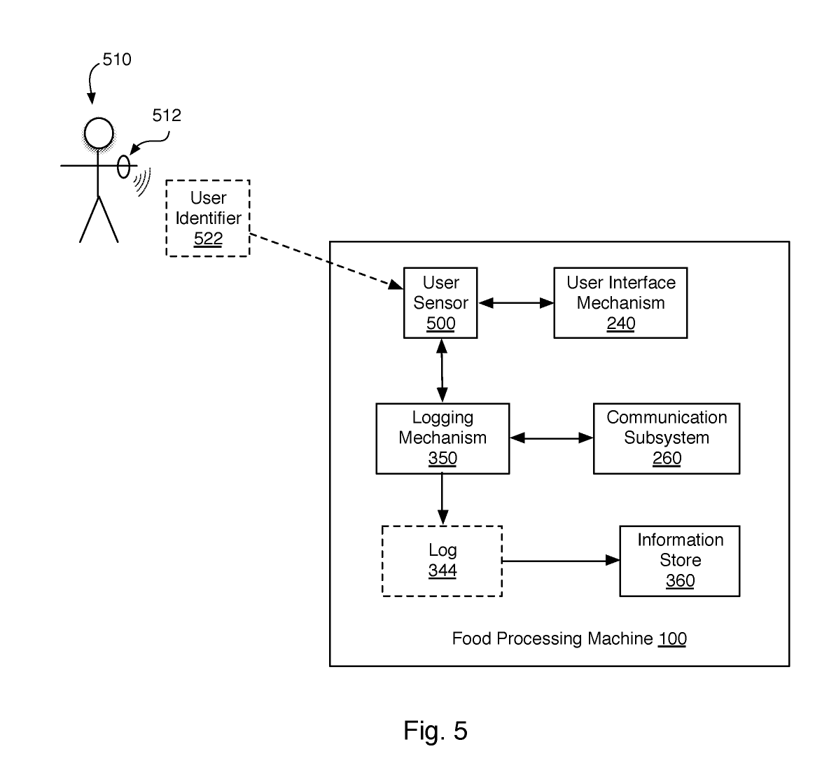

FIG. 5 illustrates an embodiment of the food processing machine 100 that includes mechanisms for identifying a user 510 of the food processing machine 100. The food processing machine 100 can include a user sensor 500 for obtaining a user identifier 522 associated with the user 510.

The user sensor 500 can obtain the user identifier 522 via the communication subsystem 260. The user sensor 500 can obtain the user identifier 522 via optical sensing, biometrics, sound, e.g., voice recognition, etc., The user sensor 500 can obtain the user identifier 522 via manual input by the user 510, e.g., via the user interface mechanism 240. For example, the user sensor 500 can prompt, via the user interface mechanism 240, for the user 510 to enter their name or select their name from a list and the user sensor 500 can map the entered name to the user identifier 522.

In one or more embodiments, the user sensor 500 can obtain the user identifier 522 from a device 512 of the user 510, e.g., a wearable device, fitness band, smart-watch, or a mobile device, smartphone, etc. For example, the user sensor 500 can use near field communication (NFC), Bluetooth, etc., to obtain the user identifier 522 from the device 512.

In one or more embodiments, the user sensor 500 can obtain the user identifier 522 from the user 510 when the code sensor 110 reads the food-pack code 112 from the food-pack 120. For example, the user sensor 500 can obtain the user identifier 522 via touchscreen input from the user 510 when the user 510 places the food-pack 120 in the food processing machine 100 to automatically scan the food-pack code 112 from the food-pack 120, or when the user 510 waves the food-pack 120 in front of the code sensor 110 to scan the food-pack code 112.

In some embodiments, the user identifier 522 can be included in the food-pack code 112.

The user identifier 522 can be a globally unique identifier that enables identification of the user 510 through a chain of commerce. For example, the user identifier 522 can be associated with the user 510 when the user 510 purchases the food-pack 120. In one or more embodiments, the logging mechanism 350 includes the user identifier 522 in the log 344 when the user 510 processes the food-pack 120 with the food processing machine 100.

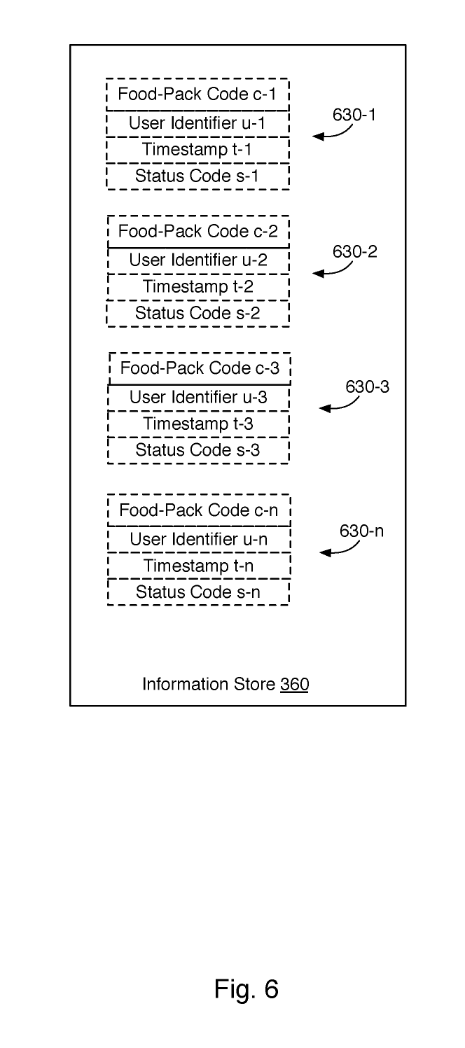

FIG. 6 shows the log 344 stored in the information store 360 as a record 630-n. Also shown are respective records 630-1 through 630-3 for respective food-packs previously processed by the food processing machine 100.

The record 630-n includes a food-pack code c-n, which is the food-pack code 112 read from the food-pack 120. The record 630-n includes the user identifier u-n, which is the user identifier 522 for the user 510. The record 630-n includes a timestamp t-n, which is a timestamp, including a date, indicating when the food-pack code 112 was read from the food-pack 120. The record 630-n includes the status code s-n pertaining to the processing of the food-pack 120.

Likewise, the records 630-1 through 630-3 include respective food-pack codes c-1 through c-3 obtained by the code sensor 110 from respective food-packs previously processed in the food processing machine 100, and respective timestamps t-1 through t-3 indicating when the food processing machine 100 processed those respective food-packs. The records 630-1 through 630-3 include respective user identifiers u-1 through u-3 obtained by the user sensor 500 from users associated with those respective food-packs. The records 630-1 through 630-3 include respective status codes s-1 through s-3 pertaining to the processing of the respective food-packs.

The records 630-1 through 630-n enable a determination of a history of the food processing machine 100 on a per user basis. For example, the records 630-1 through 630-n enable a determination of when the food processing machine 100 prepared what food-packs and for whom.

The records 630-1 through 630-n enable a determination of inventory pertaining to the food processing machine 100 on a per user basis. The records 630-1 through 630-n enable determinations of recommendations adapted to users. The records 630-1 through 630-n enable a determination of frequency of use of the food processing machine 100 per user, and frequency of use for particular food preparations per user. The records 630-1 through 630-n enable a determination of recommendations to other users of the food processing machine 100 based on uses by the user 510, and vice versa.

The records 630-1 through 630-n enable a determination of when to reorder supplies. For example, assume the user 510 purchased a supply of s0 food-packs of a particular soup on date d0. Assume further that the user identifiers u-1 through u-n, the food-pack codes c-1 through c-n, and the timestamps t-1 through t-n indicate that p0 food-packs of that particular soup have been consumed by the user 510 since date d0. If s0 minus p0 is below a predetermined threshold number, then it can indicate that a reorder of food-packs for the particular soup is in order for the user 510.

The records 630-1 through 630-n enable a variety of game-like tracking functions. For example, the records 630-1 through 630-n enable generation of information displays of how many food-packs each user of the food processing machine 100 has consumed. If a user hits a certain level of consumption, a special light can flash, or a font size can be increased for that user's name when displayed, etc., e.g., on the user interface mechanism 240 or another device.

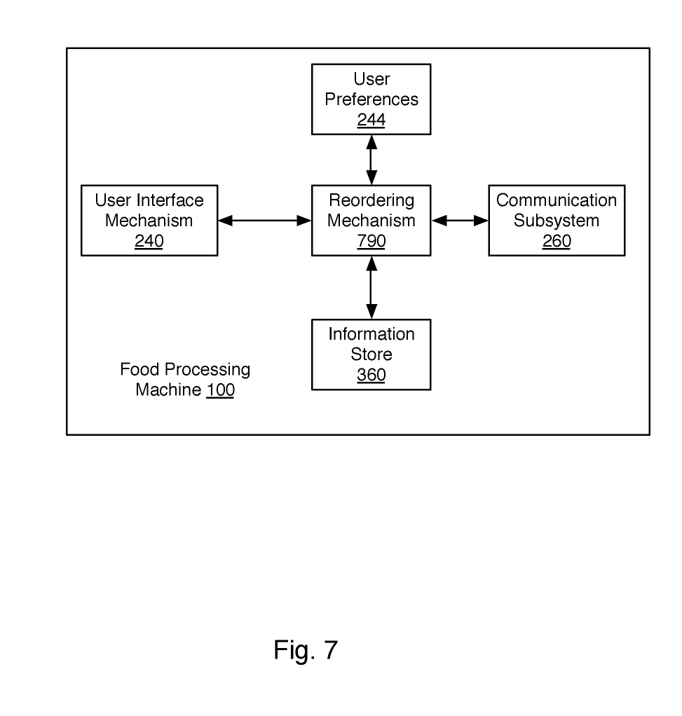

FIG. 7 illustrates an embodiment of the food processing machine 100 that includes a reordering mechanism 790. The reordering mechanism 790 can enable reordering of a set of supplies for the food processing machine 100 in response to the logs recorded in the information store 360. For example, the reordering mechanism 790 can determine when a current supply of food-packs for the user 510 is low based on the log 344 and the other logs recorded in the information store 360. The reordering mechanism 790 can generate continuous reminders, periodic reminders, etc., to reorder if supply is low for the user 510.

In one or more embodiments, the reordering mechanism 790 provides one-touch reordering. For example, the reordering mechanism 790 can generate a user interface element, e.g., a “touch to reorder” button, on the user interface mechanism 240 that, when touched by the user 510, triggers a reorder for the user 510. The reordering mechanism 790 can communicate with an external device, e.g., a mobile device of the user 510, to display the touch to reorder button and trigger a reorder on the external device.

In one or more embodiments, the food processing machine 100 provides no-touch ordering. For example, the user 510 can enter a minimum supply of food-packs in the user preferences 244. The reordering mechanism 790 can determine when an inventory of food-packs for the user 410 falls below the minimum supply and in response can initiate a reorder for the user 510.

A reorder transaction can include the reordering mechanism 790 communicating with an external device, e.g., a mobile or other app of an external device, via the communication subsystem 260, such that the external device communicates with an ordering website. A reorder transaction can include the reordering mechanism 790 communicating directly with an ordering website when the communication subsystem 260 includes web connectivity.

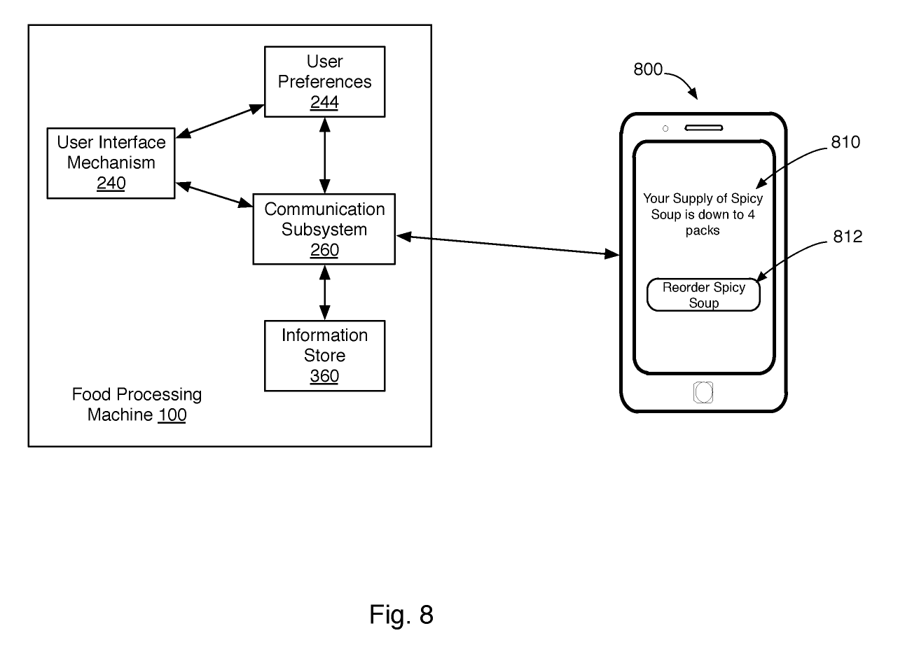

FIG. 8 shows how a mobile device 800 can be used with the food processing machine 100. The mobile device 800 can be a smartphone, tablet, wearable device, or other device, belonging to the user 510. The mobile device 800 can communicate with the food processing machine 100 via the communication subsystem 260 using, e.g., Wi-Fi, Bluetooth, NFC, etc.

The user 510 can enter the user preferences 244 via the mobile device 800. For example, the mobile device 800 can include a mobile app adapted for accessing the food processing machine 100. The mobile app can enable the user 510 to enter their user preferences on the mobile device 800, and then transfer the user preferences to the food processing machine 100 via the communication subsystem 260.

A mobile app on the mobile device 800 can obtain logs from the information store 360, or obtain uploaded logs on the fly as they are generated by the food processing machine 100, and in response generate notifications to the user 510 on the mobile device 800. A mobile app on the mobile device 800 can generate notifications pertaining to an inventory for the food processing machine 100, maintenance for the food processing machine 100, nutritional information pertaining to the user 510, use statistics for the food processing machine 100, etc., to name a few examples.

A mobile app on the mobile device 800 can provide one-touch reordering of supplies for the food processing machine 100. When a supply of food-packs for the user 510 is low, a mobile app on the mobile device 800 can generate a user interface element, e.g., a “touch to reorder” button, on the mobile device 800 that, when touched by the user 510, triggers a reorder for the user 510 via, e.g., an ordering web site accessible by the mobile device 800. In this example, a mobile app on the mobile device 800 determines that 4 food-packs of Spicy Soup remain in the inventory for the user 510 and displays a notification 810 and a button 812 that when touched by the user 510 triggers a reorder of Spicy Soup food-packs.

A mobile app on the mobile device 800 can provide no-touch reordering of supplies for the food processing machine 100. For example, a mobile app on the mobile device 800 can determine when an inventory of food-packs for the user 510 falls below the minimum supply for the user 510 specified in the user preferences 244, and in response access an ordering website.

A mobile app on the mobile device 800 can determine when a cleaning of the food processing machine 100 is needed based on the uploaded logs, or the logs stored in the information store 360. A mobile app on the mobile device 800 can generate reminders on the mobile device 800 that prompt the user 510 to run a cleaning cycle on the food processing machine 100.

A mobile app on the mobile device 800 can display promotions using popup messages, notifications, etc., to the user 510. Examples of promotions include offers for discounts, free samples, etc., on products associated with the food processing machine 100. For example, if logs uploaded by the food processing machine 100 indicate a high frequency of use for a particular food preparation then a mobile app on the mobile device 800 can generate popup promotions for relevant products.

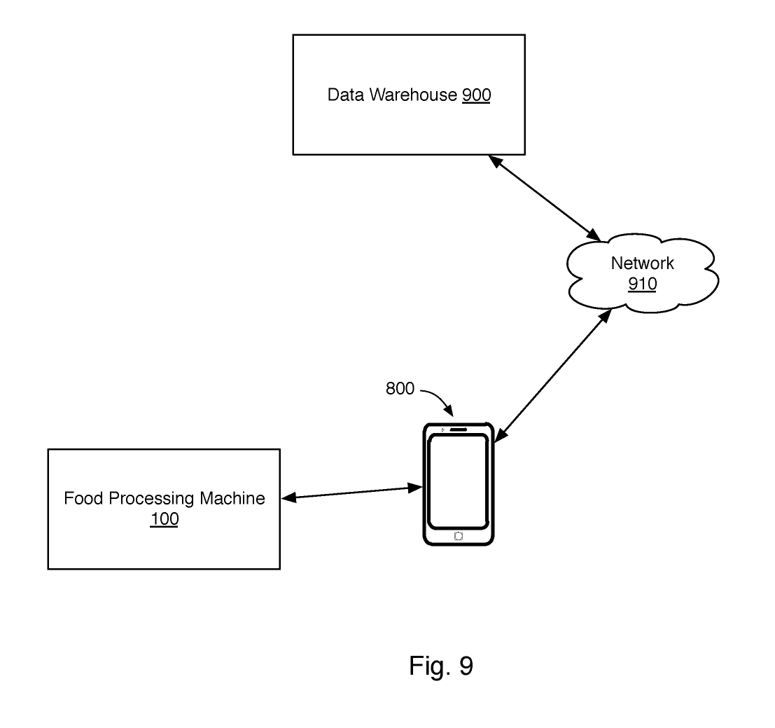

FIG. 9 illustrates an embodiment of the food processing machine 100 that communicates with a data warehouse 900, e.g., a cloud-based server, via the mobile device 800. For example, the food processing machine 100 can communicate with the mobile device 800 via Wi-Fi, Bluetooth, NFC, infrared, etc. The mobile device 800 can in turn communicate with the data warehouse 900 via a network 910 using Wi-Fi, cellular communication, etc.

The data warehouse 900 can hold data associated with the food processing machine 100. For example, the food processing machine 100 can push a log up to the data warehouse 900 via the mobile device 800 each time a food-pack is processed by the food processing machine 100. The data warehouse 900 can hold user preferences, e.g., preferences provided by the user 510. The data warehouse 900 can hold nutritional data for the food-packs for the food processing machine 100. The data warehouse 900 can hold nutritional data and consumption data pertaining to the user 510. Applications running in the data warehouse 900 can generate notifications, advertisements, promotions, etc., that target the user 510 and send the notifications, advertisements, promotions, etc., to the user 510 in emails, instant messages, mobile device notifications, etc.

In some embodiments, the communication subsystem 260 of the food processing machine 100 can communicate directly to the data warehouse 900 via the network 910, e.g., using Wi-Fi. The food processing machine 100 can upload logs and obtain promotions, advertisements, notifications, etc., using direct communication with the data warehouse 900. The food processing machine 100 can conduct one-touch reordering via the user interface mechanism 240 and direct communication with the data warehouse 900.

In one or more embodiments, the logs uploaded from the food processing machine 100 can be used to generate visual depictions of nutritional information pertaining to the user 510. For example, the device 512, e.g., a smart watch, of the user 510 can display bar graphs, tick marks, numbers, etc., that indicate the calorie consumption, protein consumption, or other nutrient information for the user 510 based on uploaded logs. The nutrition information for the food-packs can be maintained by a mobile app, or can be obtained by a mobile app from the data warehouse 900.

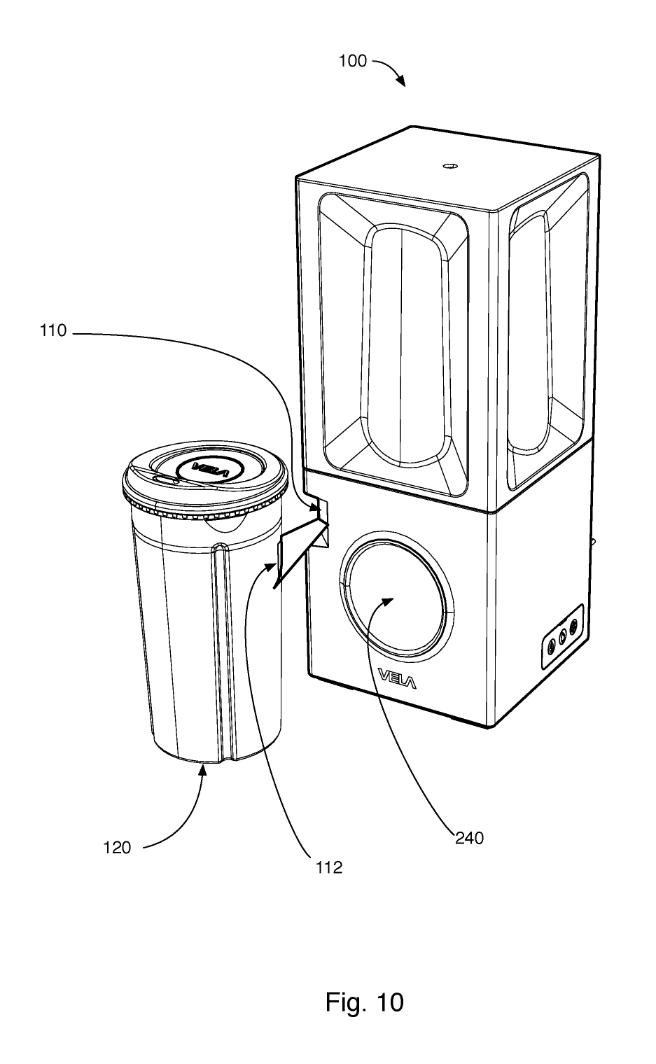

FIG. 10 illustrates an embodiment of the food processing machine 100 in which the food-pack code 112 is manually scanned from the food-pack 120. The code sensor 110 in this embodiment can be an optical sensor that scans the food-pack code 112 printed on the food-pack 120 as a user waves the food-pack 120 in front of the code sensor 110. The user interface mechanism 240 in this embodiment is a touchscreen.

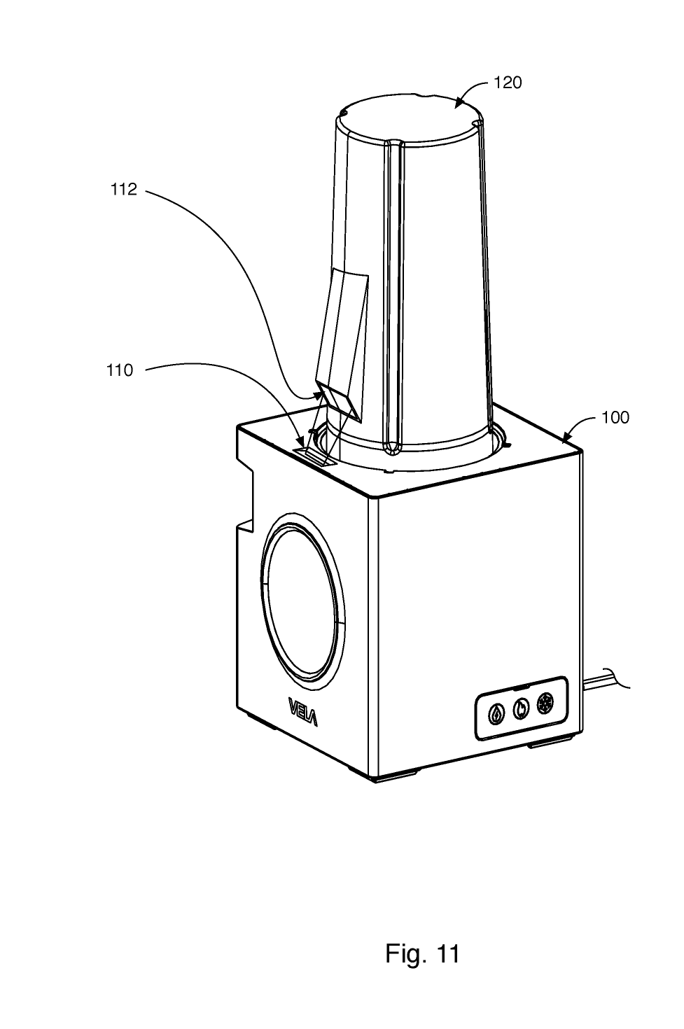

FIG. 11 illustrates an embodiment of the food processing machine 100 in which the food-pack code 112 is automatically scanned from the food-pack 120. In this example, the code sensor 110 is positioned on the food processing machine 100 so that it aligns to the food-pack code 112 on the food-pack 120 when the food-pack 120 is placed in the food processing machine 100. The code sensor 110 can automatically scan the food-pack code 112 once it is aligned to the code sensor 110. In some embodiments, the food-pack 120 can be slipped inside a carafe (not shown) and the food-pack code 112 can be automatically scanned through the walls of the carafe.

The food processing machine 100 in some embodiments can include a first code sensor adapted for automatic scanning of the food-pack code 112 along with a second code sensor adapted for manual scanning of the food-pack code 112.

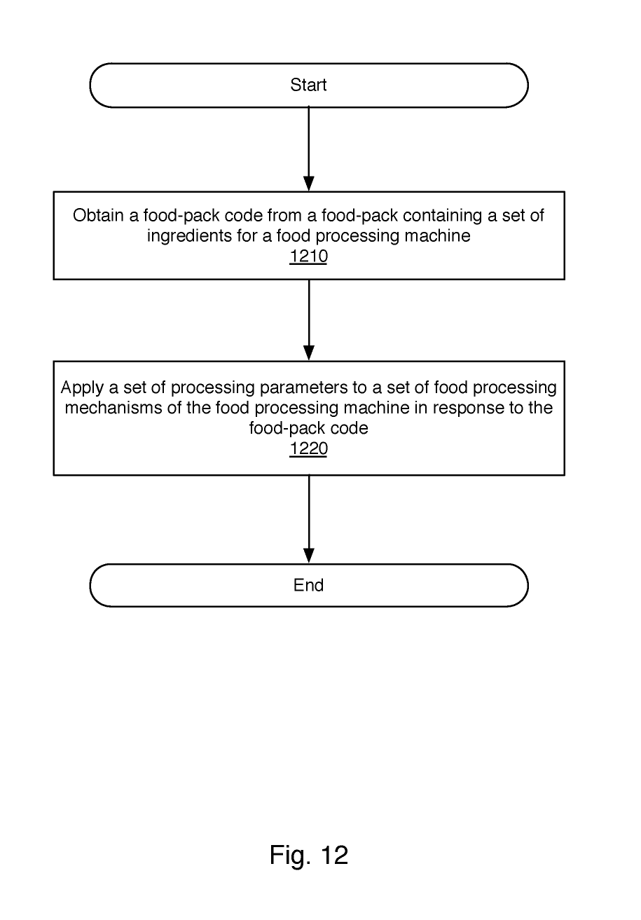

FIG. 12 illustrates a method for code-based food processing in one or more embodiments. At step 1210, a food-pack code is obtained from a food-pack containing a set of ingredients for a food processing machine. At step 1220, a set of processing parameters are applied to a set of food processing mechanisms of the food processing machine in response to the food-pack code. Applying the processing parameters can include adapting the processing parameters to user preferences.

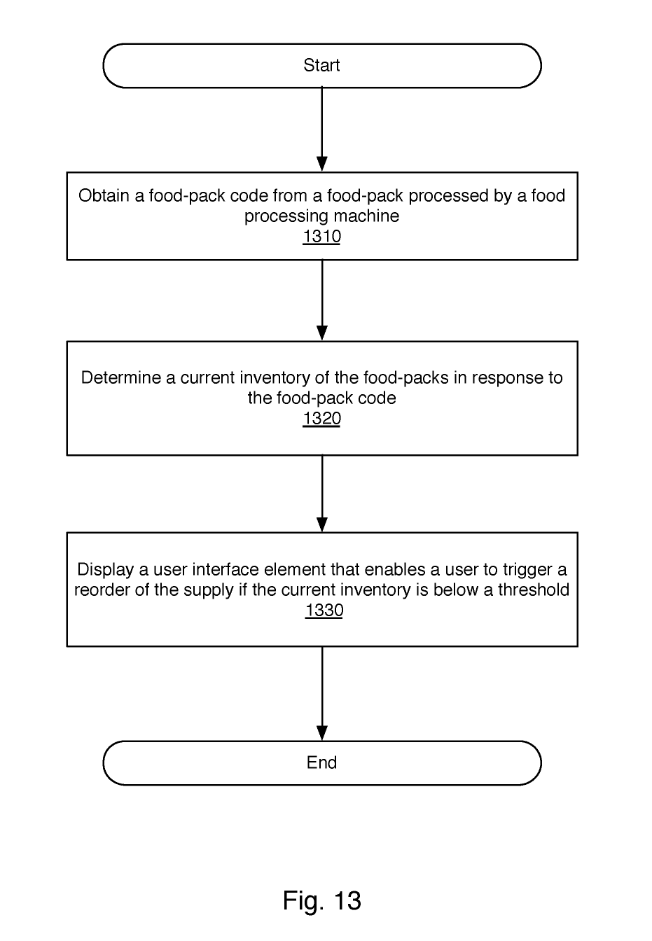

FIG. 13 illustrates a method for reordering a supply of food-packs for a code-based food processing machine in one or more embodiments. At step 1310, a food-pack code is obtained from a food-pack processed by a food processing machine. At step 1320, a current inventory of the food-packs is determined in response to the food-pack code. For example, the consumption of the food-pack identified by the food-pack code may be used to update a current running inventory number for a particular variety of food-pack for a particular user. At step 1330, a user interface element is displayed that enables a user to trigger a reorder of the supply if the current inventory is below a threshold.

The user interface element at step 1330 can be displayed on the food-processing machine or an external device. For example, a user interface element can be displayed on a touchscreen of the food processing machine, on a mobile device of the user, etc.

A user interface can be generated to enable the user to specify the threshold. For example, a user interface can be generated on a touchscreen of the food processing machine, on a mobile device of the user, etc., that enables the user to specify the threshold.

While the various steps in this flowchart are presented and described sequentially, one of ordinary skill will appreciate that some or all of the steps can be executed in different orders and some or all of the steps can be executed in parallel. Further, in one or more embodiments, one or more of the steps described below can be omitted, repeated, and/or performed in a different order. Accordingly, the specific arrangement of steps shown in FIGS. 12-13 should not be construed as limiting the scope of the invention.

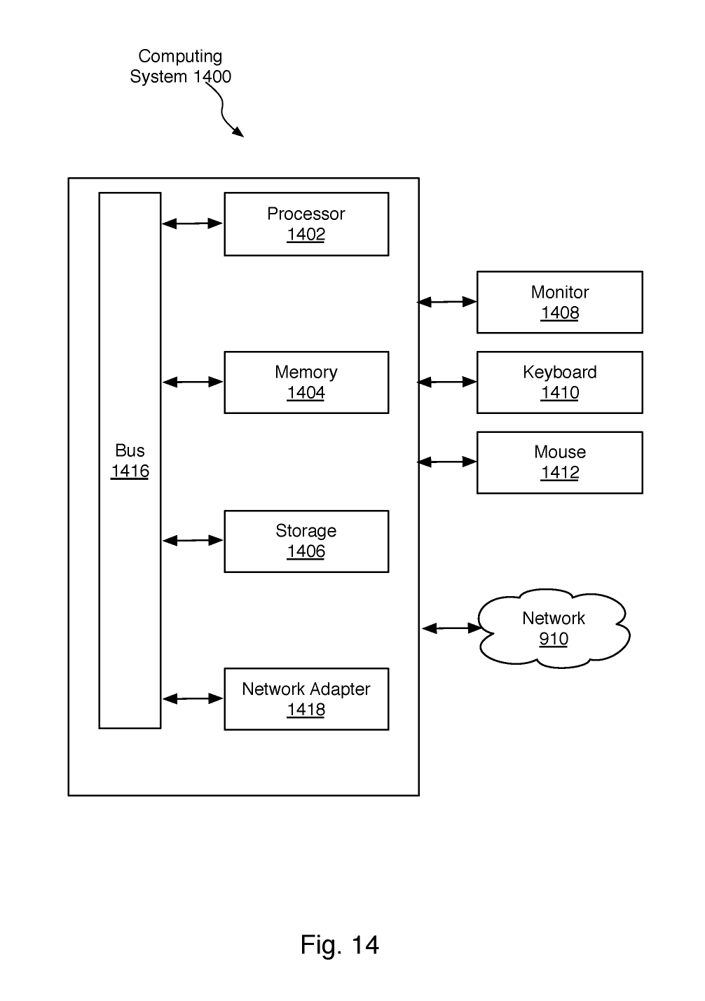

FIG. 14 illustrates a computing system 1400 upon which portions of a method for code-based food processing and reordering can be implemented. For example, the data warehouse 900 can be implemented on the computing system 1400. The computing system 1400 includes one or more computer processor(s) 1402, associated memory 1404 (e.g., random access memory (RAM), cache memory, flash memory, etc.), one or more storage device(s) 1406 (e.g., a hard disk, an optical drive such as a compact disk (CD) drive or digital versatile disk (DVD) drive, a flash memory stick, etc.), a bus 1416, and numerous other elements and functionalities. The computer processor(s) 1402 may be an integrated circuit for processing instructions. For example, the computer processor(s) may be one or more cores or micro-cores of a processor. The computing system 1400 may also include one or more input device(s), e.g., a touchscreen, keyboard 1410, mouse 1412, microphone, touchpad, electronic pen, or any other type of input device. Further, the computing system 1400 may include one or more monitor device(s) 1408, such as a screen (e.g., a liquid crystal display (LCD), a plasma display, touchscreen, cathode ray tube (CRT) monitor, projector, or other display device), external storage, input for an electric instrument, or any other output device. The computing system 1400 may be connected to the network 910 (e.g., a local area network (LAN), a wide area network (WAN) such as the Internet, mobile network, or any other type of network) via a network adapter 1418.

While the foregoing disclosure sets forth various embodiments using specific diagrams, flowcharts, and examples, each diagram component, flowchart step, operation, and/or component described and/or illustrated herein may be implemented, individually and/or collectively, using a range of processes and components.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While the invention has been described with respect to a limited number of embodiments, those skilled in the art, having benefit of this disclosure, will appreciate that other embodiments may be devised which do not depart from the scope of the invention as disclosed herein.

What is claimed is:

1. A food processing machine, comprising:
a code sensor for obtaining a food-pack code from a food-pack containing a set of ingredients for the food processing machine; and
a code handler for applying a set of processing parameters to a set of food processing mechanisms of the food processing machine in response to the food-pack code.

2. The food processing machine of claim 1, wherein the code handler adapts the processing parameters to a set of user preferences.

3. The food processing machine of claim 1, further comprising a mechanism for identifying a user of the food processing machine.

4. The food processing machine of claim 1, further comprising a logging mechanism for generating a log pertaining to the food-pack such that the log includes a set of descriptive information pertaining to a processing of the food-pack.

5. The food processing machine of claim 4, further comprising a mechanism for uploading the log.

6. The food processing machine of claim 1, further comprising a notification mechanism for generating a notification pertaining to a processing of the food-pack.

7. The food processing machine of claim 1, further comprising a notification mechanism for generating a notification pertaining to an inventory for the food processing machine.

8. The food processing machine of claim 1, further comprising a notification mechanism for generating a notification pertaining to a maintenance of the food processing machine.

9. The food processing machine of claim 1, further comprising a notification mechanism for generating a notification pertaining to a set of nutritional information for a user of the food processing machine.

10. The food processing machine of claim 1, further comprising a mechanism for reordering a set of supplies for the food processing machine in response to the food-pack code.

11. A method for food processing, comprising:
obtaining a food-pack code from a food-pack containing a set of ingredients for a food processing machine; and
applying a set of processing parameters to a set of food processing mechanisms of the food processing machine in response to the food-pack code.

12. The method of claim 11, further comprising adapting the processing parameters to a set of user preferences.

13. The method of claim 11, further comprising identifying a user of the food processing machine.

14. The method of claim 11, further comprising generating a log pertaining to the food-pack such that the log includes a set of descriptive information pertaining to a processing of the food-pack.

15. The method of claim 14, further comprising uploading the log.

16. The method of claim 11, further comprising generating a notification pertaining to a processing of the food-pack.

17. The method of claim 11, further comprising generating a notification pertaining to an inventory for the food processing machine.

18. The method of claim 11, further comprising generating a notification pertaining to a maintenance of the food processing machine.

19. The method of claim 11, further comprising generating a notification pertaining to a set of nutritional information for a user of the food processing machine.

20. The method of claim 11, further comprising generating a reorder of a set of supplies for the food processing machine in response to the food-pack code.
